(19) United States
(12) Patent Application Publication
(10) Pub. No.: US 2023/0093031 A1
(43) Pub. Date: Mar. 23, 2023

(54) TECHNIQUES FOR PREDICTING VALUE OF NFTs

(71) Applicant: Sony Interactive Entertainment Inc., Tokyo (JP)

(72) Inventors: Manjari Sharda, San Mateo, CA (US); Benjamin Andrew Rottler, San Mateo, CA (US)

(21) Appl. No.: 17/483,200

(22) Filed: Sep. 23, 2021

(51) Int. Cl. G06Q 20/06; G06N 20/00

(52) U.S. Cl. CPC G06Q 20/065; G06N 20/00

(57) ABSTRACT

A non-fungible token (NFT) associated with a computer game asset can be offered to a player or spectator of a computer game along with a predicted value of the asset generated by a machine learning (ML) model.

### FIELD

The present application relates generally to techniques for predicting value of non-fungible tokens (NFTs).

### BACKGROUND

Non-fungible tokens (NFT) are the digital world's version of physical collectables, such as but not limited to artwork. An NFT is a digital file in a block chain that proves who owns the underlying digital asset, much as a sales receipt proves ownership of a physical painting, although forging NFT proof-of-ownership is nearly impossible owing to the use of block chain technology. Like a print or painting, ownership of an NFT does not necessarily include copyright in the original work, which copyright may be retained by the creator. While anyone can view the digital asset, only the person identified in the NFT can sell the ownership of the asset, which then is recorded in the block chain. Thus, digital assets can be bought and sold like physical collectables through NFT transactions.

### SUMMARY

As understood herein, in some applications, for example, computer simulations such as computer games, a player or spectator who might be versed in computer gaming might be offered an NFT related to gaming. Such a person, however, may not be versed in valuations of NFTs.

Accordingly, a system includes at least one computer medium that is not a transitory signal and that in turn instructions executable by at least one processor to input to at least a first machine learning (ML) model at least one digital asset associated with a non-fungible token (NFT). The digital asset is related to at least one computer simulation. The instructions are executable to identify, using the first ML model, a predicted value of the NFT, and to present on at least one computer display the predicted value.

In some embodiments the instructions may be executable to input to the first ML model a training set comprising data associated with digital assets and associated values, and to train the first ML model using the training set. The data associated with digital assets may include feature vectors generated by a second ML model that identifies one or more features in digital assets.

In example implementations the instructions can be executable to present on at least one display at least one user interface (UI) that includes an offer to purchase the

NFT.

In some examples, the instructions may be executable to present on at least one display a UI that includes the predicted value and an estimated probability of the predicted value.

In non-limiting implementations, the predicated value is a first predicated value, and the instructions may be executable to present on at least one display a UI that includes the first predicted value and a second predicted value for the NFT.

In example embodiments, the instructions may be executable to present on at least one display a UI that includes an indication that a bid for the NFT lost, along with an amount of a winning bid for the NFT.

In some embodiments the instructions may be executable to present on at least one display a UI that includes an indication that a bid for the NFT won, along with an amount of an underbid for the NFT.

In another aspect, a method includes inputting to at least one machine learning (ML) model a training set of data representing digital assets and respective values of the assets to train the ML model. The method also includes inputting to the ML model at least data representing a first digital asset, and receiving from the ML model a predicted value of the first digital asset. The method entails presenting the value on at least one computer display to a prospective buyer of the first digital asset.

In another aspect, an assembly includes at least one display device (DD), at least one computer simulation controller (CSC) configured to control at least one computer simulation presented on the DD, and at least one processor configured with instructions. The instructions when executed by the processor configure the processor to, based at least in part on input from the CSC, identify a digital asset associated with the computer simulation, and to present on the DD a predicted value of a data element associated with the digital asset, the data element being configured for inclusion in a block chain.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 schematically illustrates an NFT;

FIG. 3 is a block diagram of cooperating machine learning (ML) models consistent with present principles;

FIG. 4 illustrates example ML training logic consistent with present purposes;

FIG. 5 illustrates example NFT prediction logic consistent with present principles; and

FIGS. 6-11 illustrate example user interfaces (UI) consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

A processor may be a single- or multi-chip processor that can execute logic by means of various lines such as address lines, data lines, and control lines and registers and shift registers.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

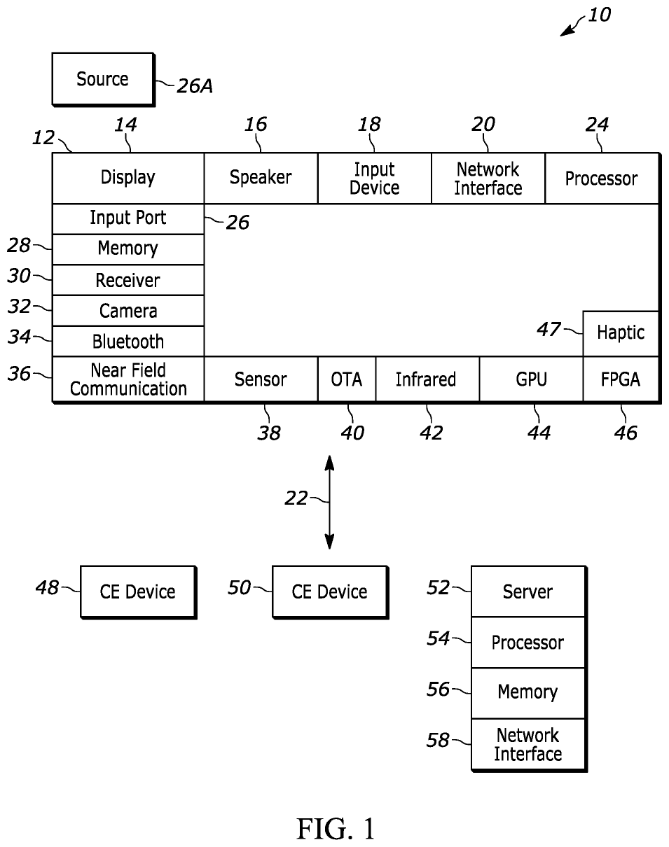

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a HMD, a wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a USB port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimension or by an event-based sensors.

Continuing the description of the AVD 12, in some embodiments the AVD 12 may include one or more cameras 32 that may be a thermal imaging camera, a digital camera such as a webcam, an event-based sensor, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command), providing input to the processor 24. The AVD 12 may include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics generators 47 may be provided for generating tactile signals that can be sensed by a person holding or in contact with the device.

Still referring to FIG. 1, in addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other devices of FIG. 1 over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown in FIG. 1 or nearby.

The components shown in the following figures may include some or all components shown in FIG. 1. The user interfaces (UI) described herein may be consolidated, expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

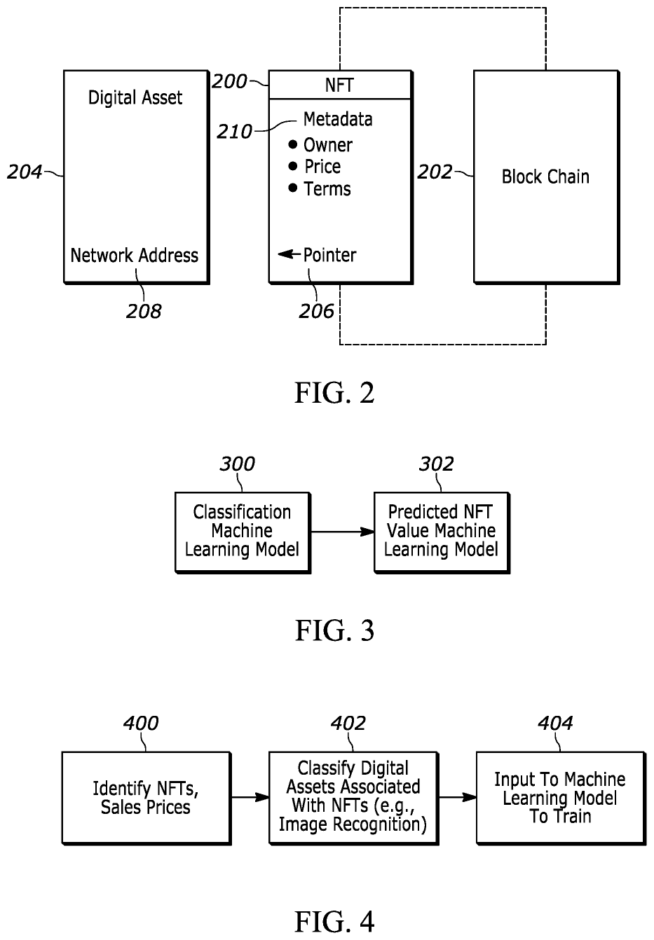

FIG. 2 illustrates a data structure 200 configured for inclusion in a block chain 202. The data structure 200 in the embodiment shown is configured as a non-fungible token (NFT) that relates to or is derived from a digital asset 204, such as an image, an audio recording, a game event, or other digitally-embodied asset that typically is generated or composed by an artist. In example implementations, the digital asset 204 may be from a computer simulation, such as a computer game, and may represent a game character, weapon, plot, or other aspect of the computer game such as an event.

In some cases, the digital asset 204 may be encoded as part of the data structure 200 (hereinafter for brevity, “NFT 200”) for inclusion into the block chain 200 or may be stored separately from the NFT 200 per se, in which case the NFT 200 may include a pointer 206 to a network address 208 of the digital asset 204.

The NFT 200 typically includes metadata 210 indicating ownership of the NFT 200 and hence of the digital asset 204. The metadata may include indication of the current and if desired past owners of the NFT 200, the price(s) paid for the ownership or other means by which ownership was acquired, the terms of the ownership (e.g., whether copyright does or does not accompany ownership), length of ownership, whether ownership can be transferred during the temporary period of ownership, etc.

FIG. 3 illustrates a classification machine learning (ML) model 300 that is configured to classify, based on a training set of digital assets (equivalently, NFTs associated with digital assets) and ground truth classifications, digital assets. More generally, the classification ML model 300 may be configured to output information representative of digital assets. Such information may include feature vectors.

In a specific implementation, the digital assets may be related to computer simulations, such as computer games, and may be images of computer game characters, weapons, or other objects, as well as audio tracks or other artist-generated assets.

One or more support vector machines (SVM), Decision Trees, and/or neural networks such as but not limited one or more convolutional neural networks (CNN) may be used to implement the classification ML model 300.

In operation, the classification ML model 300 may input to a predicted NFT value ML model 302 the information representative of digital assets to be valued. The value model 302 outputs predictions of values of the digital assets represented by the input from the classification model 300. The value model 302 may be implemented by a suitable neural network/combination of NNs.

FIG. 4 illustrates example logic for training the value ML model 302 in FIG. 3. In the figures, “NFT” may be used interchangeably with the digital asset represented by the NFT.

Commencing at block 400, a training set of digital assets/related NFTs may be identified along with ground truth valuations of those assets from historical sales or from expert pricing decisions. The ground truth valuations may include a single valuation for each asset or plural different possible valuations for each asset with respective probabilities for each valuation.

Moving to block 402, the digital assets are classified by the classification model using, e.g., image recognition, and input at block 404 along with the ground truth valuations of the assets to the value model 302 to train the model 302.

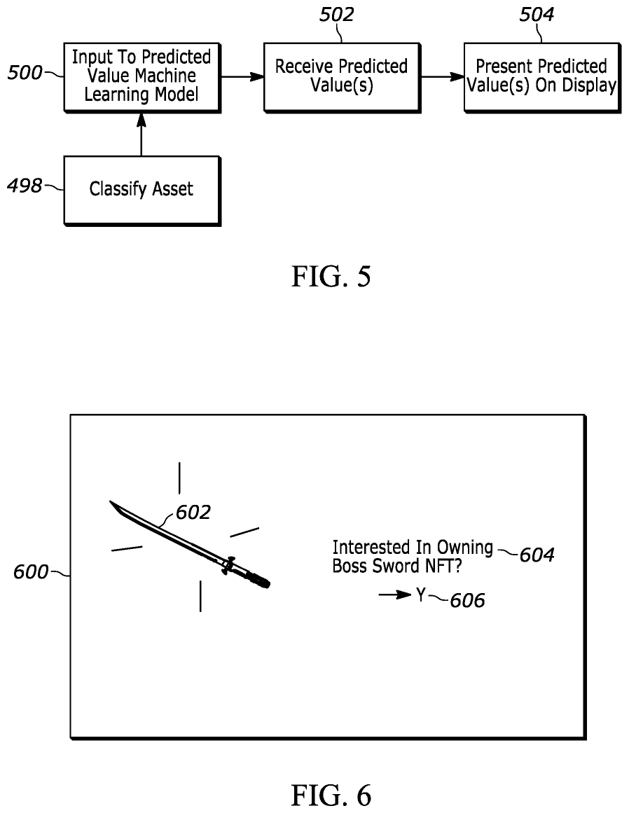

FIG. 5 illustrates logic for generating predicted values of digital assets to be offered for sale via accompanying NFTs. Commencing at block 498, an asset is classified as described to generate data representative of the asset, such as feature vectors. This information is input at block 500 to the value model 302, which outputs predicted value(s) for each asset that are received at block 502. The predicted value(s) are output at block 504 on a display, audibly and/or visibly and/or tactilely.

FIGS. 6-10 illustrate user interfaces (UI) that may be presented on a display 600 such as any display herein. FIG. 6 includes an image 602 of a digital asset to be sold as an NFT, in this case, an image of a sword of a “boss” computer game character. The UI may include a solicitation 604 to purchase the NFT associated with the digital asset illustrated at 602, along with an acceptance selector 606 selectable to buy the NFT. If the accept selector 606 is selected, the digital asset may be input to the value model 302 shown in FIG. 3 to generate one or more predicted valuations for the asset.

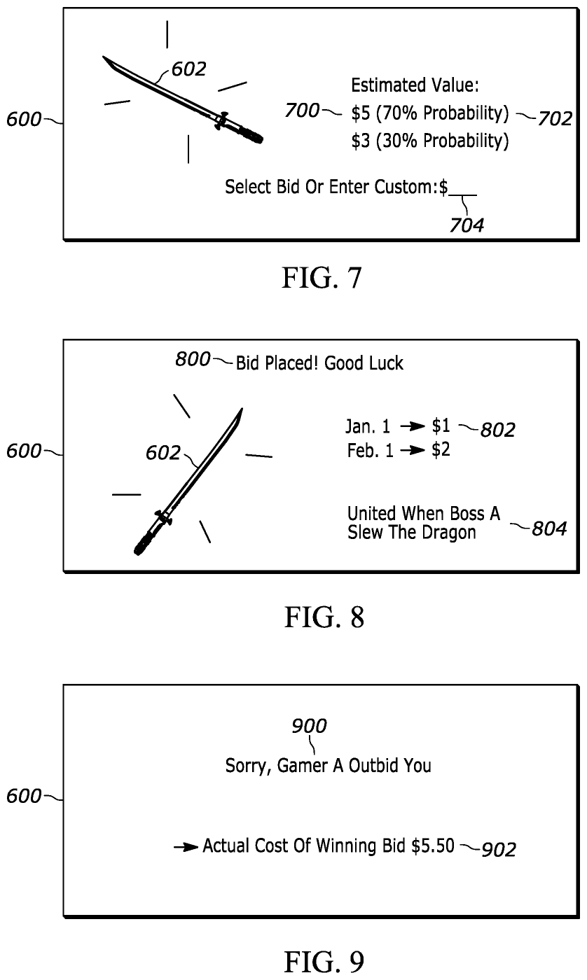

FIG. 7 illustrates a UI that may be presented responsive to selection of the accept selector 606 in FIG. 6. In the example shown, the value model 302 has generated two predicted valuations 700 with respective probabilities 702. The UI may include a field 704 for the user to select one of the valuations or enter a custom bid for the NFT.

Responsive to a price being selected in FIG. 7, FIG. 8 illustrates a UI that indicates at 800 that the price has been entered for the asset depicted at 602. The UI 800 may include historical valuation information of the NFT as indicated at 802 and an indication 804 as to what spawned the minting of the NFT. The user may be required to pay to unlock some or all of this information.

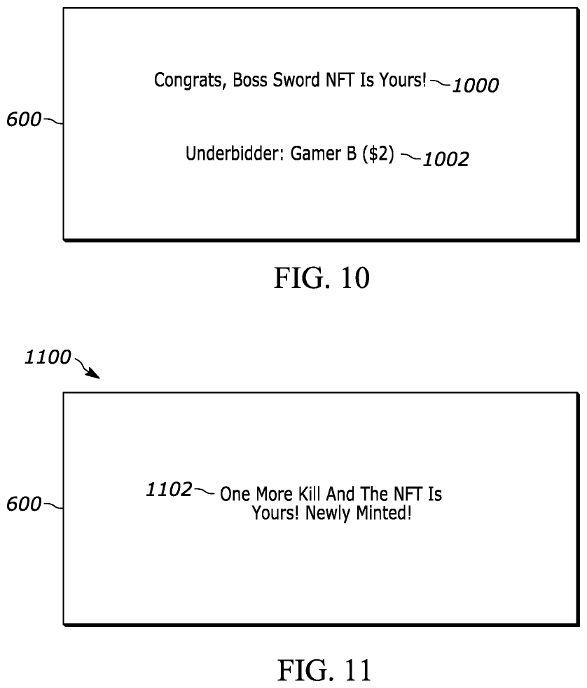

Upon elapse of the bidding process, FIGS. 9 and 10 illustrate UIs that may be presented respectively if the user has lost the bid or won the bid.

More specifically, FIG. 9 illustrates a UI indicating at 900 that the user has lost the bid. The UI may also indicate at 902 what the winning bid was. The winning bidder's name also may be indicated.

In contrast, FIG. 10 indicates at 1000 that the user has won the bid for the NFT associated with the digital asset. If desired, this UI also may indicate at 1002 who the underbidder was, and how much the underbidder bid.

In addition to the above, present principles provide the following techniques. The rarity of an item underlying an NFT may be known and may increase the value of the

NFT. For instance, if an item underlying an NFT is permitted to be used ten times and seven uses have been consumed, the value of the NFT may rise until all ten uses have been effected, at which point the value may be reduced. The value of an NFT may depend on whether the underlying asset can be replicated easily (less valuable) or not (more valuable. The value may depend on whether the underlying asset is fungible (less valuable) or non-fungible (more fungible). The value of an NFT may depend on the value of the item to a social community. If an NFT is minted based on an achievement such winning a tournament or other computer simulation achievement, the difficulty of achievement can impact value of the NFT. A higher number of times an asset underlying an NFT was watched or shared can increase the value of an NFT and a lower number of watch/shares can lower the value. The value of an NFT may be keyed to group achievement. These are but a few examples of NFT value that may be provided in the training set to the ML model.

FIG. 11 illustrates a user interface (UI) 1100 for visualizing an impending NFT minting. A prompt 1102 can indicate to the user/player that the user/player is getting close to acquiring a newly minted NFT, along with information on how to create the NFT. Thus, the user/player may have to meet certain conditions such as completing certain tasks or achievements to cause an NFT to be minted in the first place.

While the particular embodiments are herein shown and described in detail, it is to be understood that the subject matter which is encompassed by the present invention is limited only by the claims.

1. A system comprising:
at least one computer medium that is not a transitory signal and that comprises instructions executable by at least one processor to:
train at least a first machine learning (ML) model using a training set comprising:
valuations of digital assets from at least one of: historical sales, or expert pricing decisions;
the training set further comprising at least one of A, B, C, or combinations thereof, wherein A comprises respective rarities associated with at least some respective digital assets such that valuation of a respective digital asset corresponds to the respective rarity, B comprises respective values of at least some respective digital assets to at least one social community, and C comprises respective values of at least some respective digital assets based on respective number of times respective digital assets were watched or shared;
input to the at least first machine learning (ML) model at least one digital asset associated with a non-fungible token (NFT), the digital asset being related to at least one computer simulation;
identify, using the first ML model, a predicted value of the NFT; and
present on at least one computer display the predicted value.

2. The system of claim 1, comprising the at least one processor.

3. (canceled) .

4. The system of caim 1 wherein the data associated with digital assets comprise feature vectors generated by a second ML model that identifies one or more features in digital assets.

5. The system of claim 1, wherein the instructions are executable to:
present on at least one display at least one user interface (UI) comprising:
an offer to purchase the NFT.

6. The system of claim 1, wherein the instructions are executable to:
present on at least one display at least one user interface (UI) comprising:
the predicted value; and
an estimated probability of the predicted value.

7. The system of claim 1, wherein the predicted value is a first predicted value, and the instructions are executable to:
present on at least one display at least one user interface (UI) comprising:
the first predicted value and a second predicted value for the NFT.

8. The system of claim 1, wherein the instructions are executable to:
present on at least one display at least one user interface (UI) comprising:
an indication that a bid for the NFT lost, along with an amount of a winning bid for the NFT.

9. The system of claim 1, wherein the instructions are executable to:
present on at least one display at least one user interface (UI) comprising:
an indication that a bid for the NFT won, along with an amount of an underbid for the NFT.

10. A method for training at least one machine learning (ML) model, comprising:
inputting to the at least one machine learning (ML) model a training set of data representing digital assets and respective values of the assets to train the ML model; wherein the training set comprises:
ground truth valuations of digital assets from at least one of: historical sales, or expert pricing decisions; the training set further comprising at least one of A, B, C, or combinations thereof, wherein A comprises respective rarities associated with at least some respective digital assets such that valuation of a respective digital asset corresponds to the respective rarity, B comprises respective values of at least some respective digital assets to at least one social community, and C comprises respective values of at least some respective digital assets based on respective number of times respective digital assets were watched or shared; and
using the ML model to provide a valuation of at least one digital asset for presentation of the value in human-perceptible form.

11. The method of claim 10, wherein the ML model is a first ML model and wherein the data representing digital assets comprise feature vectors generated by a second ML model that identifies one or more features in digital assets.

12. The method of claim 10, comprising:
presenting on at least one display at least one user interface (UI) comprising an offer to purchase at least one digital asset.

13. The method of claim 10, comprising:
inputting to the ML model at least data representing a first digital asset;
receiving from the ML model a predicted value of the first digital asset; and
presenting on at least one display at least one user interface (UI) comprising the predicted value and an estimated probability of the predicted value.

14. The method of claim 10, wherein the training set comprises:
respective rarities associated with at least some respective digital assets such that valuation of a respective digital asset corresponds to the respective rarity.

15. The method of claim 10,
wherein the training set comprises:
respective values of at least some respective digital assets to at least one social community.

16. The method of claim 10, wherein the training set comprises:
respective values of at least some respective digital assets based on respective number of times respective digital assets were watched or shared.

17. An assembly comprising:
at least one display device (DD);
at least one computer simulation controller (CSC) configured to control at least one computer simulation presented on the DD; and
at least one processor configured with instructions to:
based at least in part on input from the CSC, identify a digital asset associated with the computer simulation; and
present on the DD a predicted value of a data element associated with the digital asset, the data element being configured for inclusion in a block chain.

18. The assembly of claim 17, wherein the processor is configured with instructions to present on the DD a probability associated with the predicted value.

19. The assembly of claim 17, wherein the processor is configured with instructions to present on the DD plural predicated values for the digital asset.

20. The assembly of claim 17, wherein the processor is configured with instructions to present on the DD an actual amount of a winning bid or an actual amount of a losing bid for the digital asset.
